(19) United States
(12) Patent Application Publication
(10) Pub. No.: US 2025/0184433 A1
(43) Pub. Date: Jun. 5, 2025

(54) ELECTRONIC APPARATUS, ELECTRONIC SYSTEM, NOISE DETERMINATION METHOD, AND NON-TRANSITORY RECORDING MEDIUM

(71) Applicant: Mitsuo ITO, KANAGAWA (JP)

(72) Inventor: Mitsuo ITO, KANAGAWA (JP)

(21) Appl. No.: 18/945,594

(22) Filed: Nov. 13, 2024

(30) Foreign Application Priority Data
Nov. 30, 2023 (JP) 2023-202487

(51) Int. Cl. H04N 1/00

(52) U.S. Cl. CPC H04N 1/00037; H04N 1/00015

(57) ABSTRACT

An electronic apparatus includes an electrical component to generate a signal. The electronic apparatus includes circuitry to determine, based on an operating status of the electronic apparatus, a type of noise indicating that the noise included in the signal is a normal noise not caused by an abnormality of the electronic apparatus or an abnormal noise caused by the abnormality of the electronic apparatus.

### CROSS-REFERENCE TO RELATED APPLICATIONS

This patent application is based on and claims priority pursuant to 35 U.S.C. § 119(a) to Japanese Patent Application No. 2023-202487, filed on Nov. 30, 2023, in the Japan Patent Office, the entire disclosure of which is hereby incorporated by reference herein.

### BACKGROUND

### Technical Field

The present disclosure relates to an electronic apparatus, an electronic system, a noise determination method, and a non-transitory recording medium.

### Related Art

In the related art, an electronic apparatus such as an image forming apparatus has been proposed to facilitate the identification of a source of noise when it is determined that the occurrence of an abnormality in an electrical component of the electronic apparatus is caused by the noise. When the number of noise occurrences exceeds a predetermined threshold value, the electronic apparatus determines that the abnormality has occurred in the electronic apparatus and forcibly stops the operation of the electronic apparatus.

### SUMMARY

According to one or more embodiments of the present disclosure, an electronic apparatus includes an electrical component to generate a signal. The electronic apparatus includes circuitry to determine, based on an operating status of the electronic apparatus, a type of noise indicating that the noise included in the signal is a normal noise not caused by an abnormality of the electronic apparatus or an abnormal noise caused by the abnormality of the electronic apparatus.

According to one or more embodiments of the present disclosure, an electronic system includes an electronic apparatus and an inference server. The electronic apparatus includes an electrical component to generate a signal. The inference server is communicably connected with the electronic apparatus and includes circuitry. The circuitry determines a type of noise indicating that the noise included in the signal is a normal noise not caused by an abnormality of the electronic apparatus or an abnormal noise caused by the abnormality of the electronic apparatus, by inferring the type of noise in the signal based on the signal and data indicating an operating status of the electronic apparatus using a pre-trained machine learning model. The pre-trained machine learning model inputs the signal and the data indicating the operating status of the electronic apparatus as input data and outputs the type of noise as output data.

According to one or more embodiments of the present disclosure, a noise determination method includes acquiring a signal generated in an electrical component included in an electronic apparatus. The noise determination method includes determining, based on an operating status of the electronic apparatus, a type of noise indicating that the noise included in the signal is a normal noise not caused by an abnormality of the electronic apparatus or an abnormal noise caused by the abnormality of the electronic apparatus.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic diagram illustrating a communication system according to an embodiment;

FIG. 2 is a block diagram illustrating a hardware configuration of a multi-function peripheral, which is an example of an image forming apparatus;

FIG. 3 is a schematic diagram illustrating an electrical hardware configuration of an engine controller illustrated in FIG. 2;

FIG. 4 is a block diagram illustrating an electrical hardware configuration of a machine learning server, a data management server, and a user terminal;

FIG. 5 is a block diagram illustrating a functional configuration of the machine learning server during a learning phase;

FIG. 6 is a functional block diagram illustrating the image forming apparatus in an inference phase;

FIG. 7 is a diagram illustrating the details of the operating status of the image forming apparatus;

FIG. 8 is a sequence diagram illustrating an example of a process performed by the communication system;

FIG. 9 is a flowchart illustrating an operation in the learning phase;

FIG. 10 is a flowchart illustrating an operation in the inference phase;

FIG. 11 is a block diagram illustrating an example of another functional configuration of the machine learning server (an inference server) in the inference phase;

FIG. 12 is a sequence diagram illustrating another example 1 of a process performed by the communication system;

FIG. 13 is a functional block diagram illustrating the image forming apparatus in the learning phase; and

FIG. 14 is a sequence diagram illustrating another example 2 of a process performed by the communication system.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Hereinafter, a description is given of some embodiments of the present disclosure with reference to the attached drawings.

### Overall Configuration of System

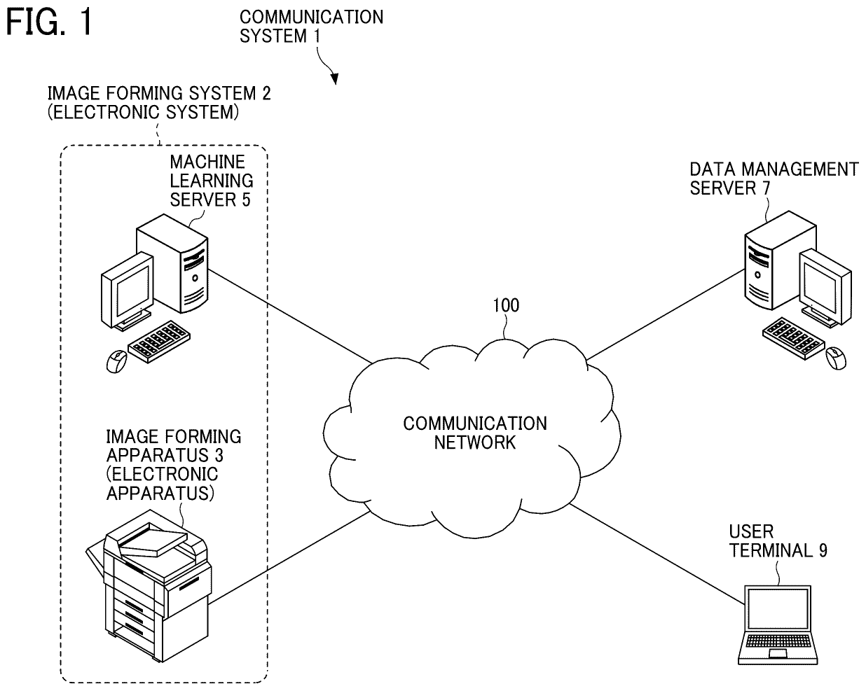

Referring to FIG. 1, a description is given of a general arrangement of a communication system 1 according to the present embodiment. FIG. 1 is a schematic diagram illustrating the communication system 1 according to the present embodiment.

As illustrated in FIG. 1, the communication system 1 according to the present embodiment includes an image forming apparatus 3, a machine learning server 5, a data management server 7, and a user terminal 9. The image forming apparatus 3, the machine learning server 5, the data management server 7, and the user terminal 9 can communicate with each other via a communication network 100 such as the Internet and a local area network (LAN). The communication network 100 may be either a wireless network or a wired network.

Examples of the image forming apparatus 3 include a multi-function peripheral, product, or printer (MFP), a printer, and a facsimile machine. The image forming apparatus 3 has a pre-trained machine learning model Mb using Artificial Intelligence (AI), which performs a predetermined inference. For example, the image forming apparatus 3 is provided with an electrical component that generates a signal. Based on the operating status of the image forming apparatus 3, the image forming apparatus 3 determines the type of noise that indicates that the noise included in the signal in the image forming apparatus 3 is normal noise that is not caused by the abnormality of the image forming apparatus 3 or abnormal noise that is caused by the abnormality of the image forming apparatus 3. The image forming apparatus 3 is one example of an electronic apparatus.

The machine learning server 5 performs machine learning of a machine learning model Ma to generate the pre-trained machine learning model Mb. The image forming apparatus 3 and the machine learning server 5 together forms an image forming system 2.

The data management server 7 collects training data used for machine learning by the machine learning server 5 from an external device such as the image forming apparatus 3. The data management server 7 transmits the training data to the machine learning server 5.

The user terminal 9 transmits a request to execute a job such as printing to the image forming apparatus 3. The user terminal 9 is, for example, a personal computer (PC), a tablet terminal, or a smartwatch.

### Hardware Configuration

### Image Forming Apparatus

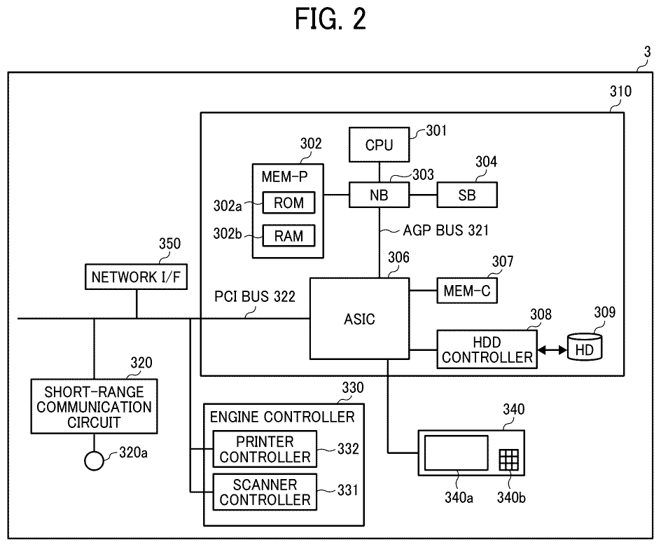

FIG. 2 is a block diagram illustrating an example of a hardware configuration of the MFP, which is an example of the image forming apparatus 3.

The image forming apparatus 3 includes a controller 310, a short-range communication circuit 320, an engine controller 330, a control panel 340, and a network interface (I/F) 350.

The controller 310 includes a central processing unit (CPU) 301 as a main processor, a system memory (MEM-P) 302, a north bridge (NB) 303, a south bridge (SB) 304, an application-specific integrated circuit (ASIC) 306, a local memory (MEM-C) 307 as a storage unit, a hard disk drive (HDD) controller 308, and a hard disk (HD) 309 as a storage unit. The NB 303 and the ASIC 306 are connected through an accelerated graphics port (AGP) bus 321.

The CPU 301 is a processor that performs the overall control of the image forming apparatus 3. The NB 303 connects the CPU 301 to the MEM-P 302, the SB 304, and the AGP bus 321. The NB 303 includes a memory controller that controls reading or writing of various data from or to the MEM-P 302, a peripheral component interconnect (PCI) master, and an AGP target.

The MEM-P 302 includes a read-only memory (ROM) 302a as a memory that stores program and data for implementing various functions of the controller 310. The MEM-P 302 further includes a random-access memory (RAM) 302b as a memory that deploys the program and data, or as a drawing memory that stores drawing data for printing. The program stored in the RAM 302b may be stored in any computer-readable recording medium, such as a compact disc-read-only memory (CD-ROM), compact disc-recordable (CD-R), or digital versatile disc (DVD), in an installable or executable file format for distribution.

The SB 304 is a bridge that connects the NB 303 to PCI devices and peripheral devices. The ASIC 306 is an integrated circuit (IC) dedicated to image processing and includes hardware elements for image processing. The ASIC 306 serves as a bridge to connect the AGP bus 321, a PCI bus 322, the HDD controller 308, and the MEM-C 307 to each other. The ASIC 306 includes a PCI target, an AGP master, an arbiter (ARB) as a central processor of the ASIC 306, a memory controller that controls the MEM-C 307, a plurality of direct memory access controllers (DMACs), and a PCI unit. For example, the DMACs convert the coordinates of image data with a hardware logic to rotate an image based on the image data. The PCI unit transfers data between a scanner controller 331 and a printer controller 332 through the PCI bus 322. The ASIC 306 may be connected to a universal serial bus (USB) interface, or the Institute of Electrical and Electronics Engineers 1394 (IEEE1394) interface.

The MEM-C 307 is a local memory used as a buffer for image data to be copied or a code buffer. The HD 309 is a storage for storing image data, font data used in printing, and forms. The HDD controller 308 controls the reading or writing data from or to the HD 309 under the control of the CPU 301. The AGP bus 321 is a bus interface for a graphics accelerator card, which has been proposed to accelerate graphics processing. Through directly accessing the MEM-P 302 by high throughput, the speed of the graphics accelerator card increases.

The short-range communication circuit 320 is provided with a short-range communication antenna 320a. The short-range communication circuit 320 is a communication circuit in compliance with, for example, near field communication (NFC) or BLUETOOTH.

The engine controller 330 includes the scanner controller 331 and the printer controller 332. The control panel 340 includes a panel display 340a and an operation panel 340b. The panel display 340a is implemented by, for example, a touch panel that displays current settings or a selection screen to receive a user input. The operation panel 340b includes a numeric keypad that receives set values of various image forming parameters such as image density parameter and a start key that receives an instruction for starting copying. The controller 310 controls overall operation of the image forming apparatus 3. For example, the controller 310 controls drawing, communication, or user inputs to the control panel 340. The scanner controller 331 and the printer controller 332 each performs various image processing, such as error diffusion or gamma conversion.

In response to an instruction to select a specific application through the control panel 340, for example, using a mode switch key, the image forming apparatus 3 selectively performs a document box function, a copier function, a printer function, and a facsimile function. When the document box function is selected, the image forming apparatus 3 operates in a document box mode. When the copier function is selected, the image forming apparatus 3 operates in a copy mode. When the printer function is selected, the image forming apparatus 3 operates in a printer mode. When the facsimile function is selected, the image forming apparatus 3 operates in a facsimile mode.

The network I/F 350 controls communication of data with an external device through the communication network 100. The short-range communication circuit 320 and the network I/F 350 are electrically connected to the ASIC 306 through the PCI bus 322.

### Engine Controller

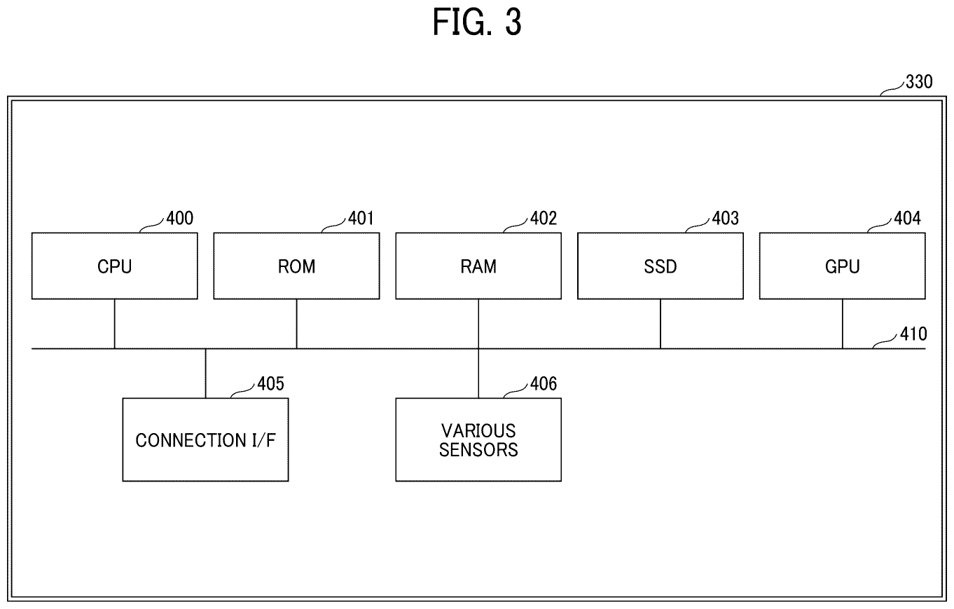

FIG. 3 is a schematic diagram of an electrical hardware configuration of the engine controller 330 illustrated in FIG. 2.

As illustrated in FIG. 3, the engine controller 330 includes a CPU 400, a ROM 401, a RAM 402, and a solid state drive (SSD) 403, a graphics processing unit (GPU) 404, a connection I/F 405, various sensors 406, and a bus line 410.

The CPU 400 controls the overall operation of the engine controller 330. The ROM 401 stores a program such as an initial program loader (IPL) used for driving the CPU 400. The RAM 402 is used as a work area for the CPU 400.

The SSD 403 reads or writes various data under control of the CPU 400. In alternative to the SSD 403, the engine controller 330 may include an HDD. The GPU 404 is a semiconductor chip dedicated to processing a graphical image. The GPU 404 may be omitted.

The connection I/F 405 is an interface for connecting various devices or electrical components included in the image forming apparatus 3.

The various sensors 406 are a group of sensors for detecting the operation of the engine controller 330 and other devices and the environment (e.g., temperature, humidity.)

Examples of the bus line 410 include an address bus and a data bus, which electrically connect the components including the CPU 400 one another.

### Machine Learning Server

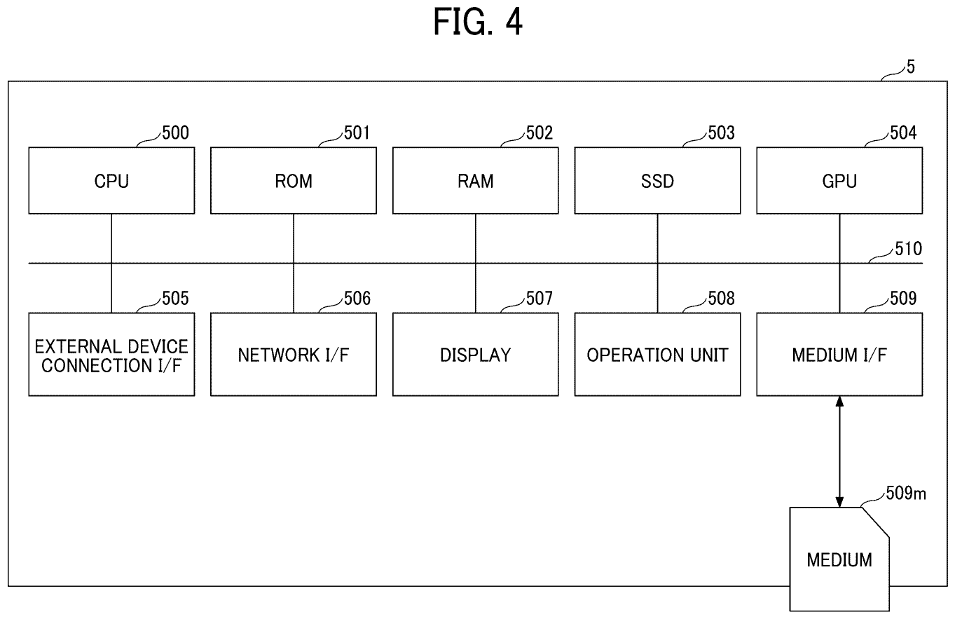

FIG. 4 is a block diagram illustrating an electrical hardware configuration of the machine learning server 5, the data management server 7, and the user terminal 9. Since the data management server 7 and the user terminal 9 have the same configuration as the machine learning server 5, the machine learning server 5 is described below.

As illustrated in FIG. 4, the machine learning server 5 is implemented as a computer that includes a CPU 500, a ROM 501, a RAM 502, an SSD 503, a GPU 504, an external device connection I/F 505, a network I/F 506, a display 507, an operation unit 508, a medium I/F 509, and a bus line 510.

The CPU 500 controls the overall operation of the machine learning server 5. The ROM 501 stores a program such as the IPL used for driving the CPU 500. The RAM 502 is used as a work area for the CPU 500.

The SSD 503 reads or writes various data under control of the CPU 500. In alternative to the SSD 503, the machine learning server 5 may include an HDD. The GPU 504 is a semiconductor chip dedicated to processing a graphical image.

The external device connection I/F 505 is an interface for connecting the machine learning server 5 to various external devices. Examples of the external device include a display, a speaker, a keyboard, a mouse, a USB memory, and a printer.

The network I/F 506 is an interface that controls communication of data with an external device through the communication network 100.

The display 507 is an example of a display means such as a liquid crystal display (LCD) or an organic electroluminescence (EL) display that displays various images.

Examples of the operation unit 508 include a keyboard and a pointing device. The operation unit 508 is an example of an input means for receiving an input operation for inputting, for example, characters, numerical values, or various instructions.

The medium I/F 509 controls reading or writing (storing) of data from or to a recording medium 509m such as a flash memory. Examples of the recording medium 509m include a DVD and a BLU-RAY DISC.

Examples of the bus line 510 include an address bus and a data bus, which electrically connect the components including the CPU 500 one another.

### Functional Configuration

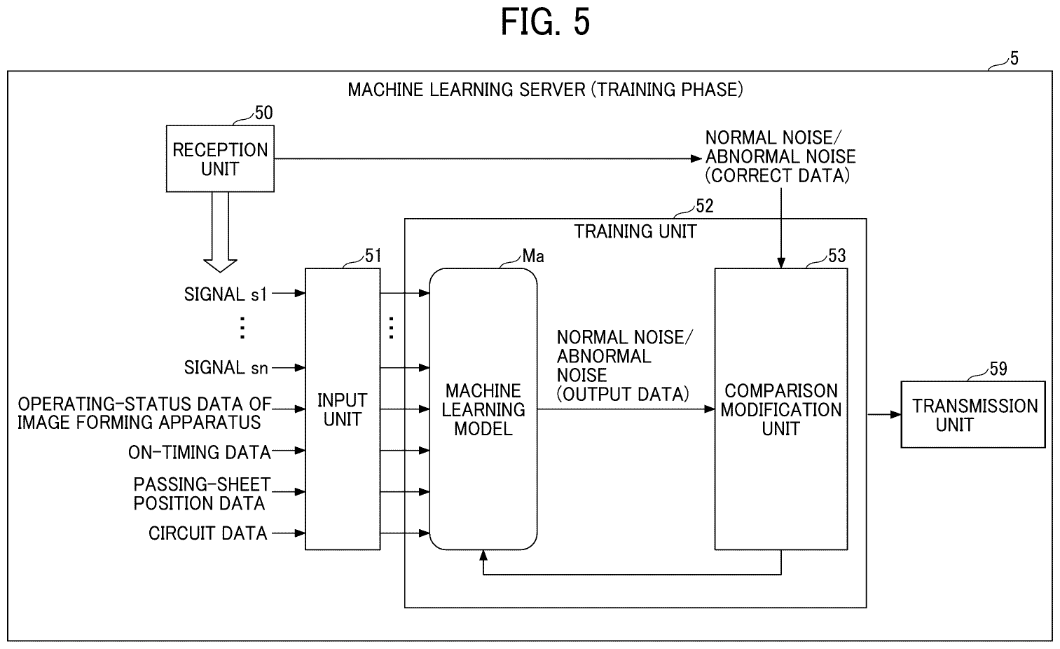

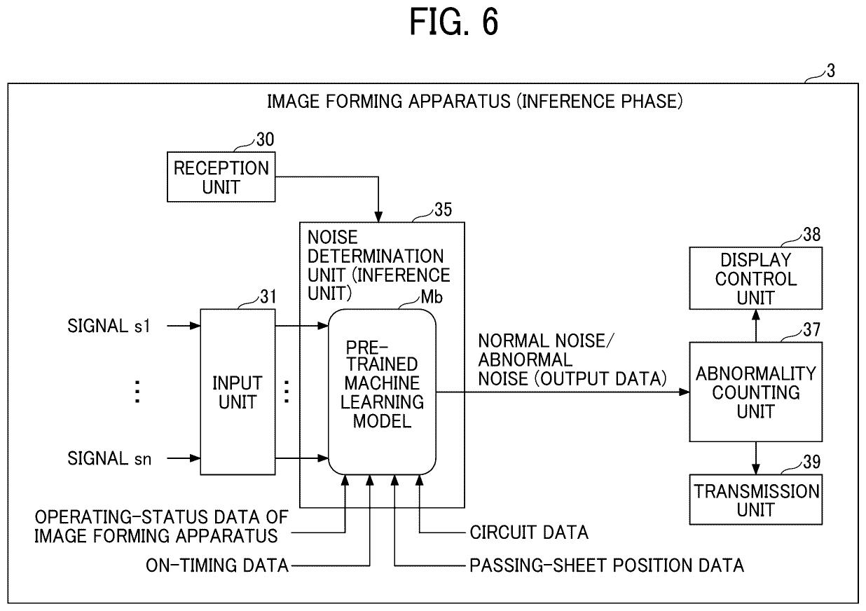

Referring next to FIG. 5 and FIG. 6, a functional configuration of the communication system 1 according to the present embodiment is described.

### Learning Phase

FIG. 5 is a block diagram illustrating a functional configuration of the machine learning server 5 during a learning phase. As illustrated in FIG. 5, the machine learning server 5 in the learning phase includes a reception unit 50, an input unit 51, a training unit 52, and a transmission unit 59. The reception unit 50 and the transmission unit 59 are functions implemented by instructions of the CPU 301 illustrated in FIG. 2 based on a program. The input unit 51 and the training unit 52 are functions implemented by instructions of the CPU 400 or the GPU 404 illustrated in FIG. 3 based on a program.

The reception unit 50 receives the training data from the data management server 7. The training data includes a dataset of input data and correct answer data. The input data include signal levels of multiple signals s1 to sn, the operating-status data of the image forming apparatus 3, ON timing data indicating ON timing, passing-sheet position data indicating passing-sheet position, and the circuit data indicating the impedance of a circuit. The training data includes results indicating that the noise is normal noise or abnormal noise as each correct answer data (teacher data) that is associated with each of the input data.

Examples of the signals s1 to sn include motor lock detection signals and interlock signals. The motor lock detection signals are used to signal that motor rotation has stabilized. The interlock signals indicate the open/close status of an interlock. The interlock is a switch that mechanically turns on or off relatively high voltages. The interlock is likely to generate large noise or inrush currents at the timing the interlock is turned on.

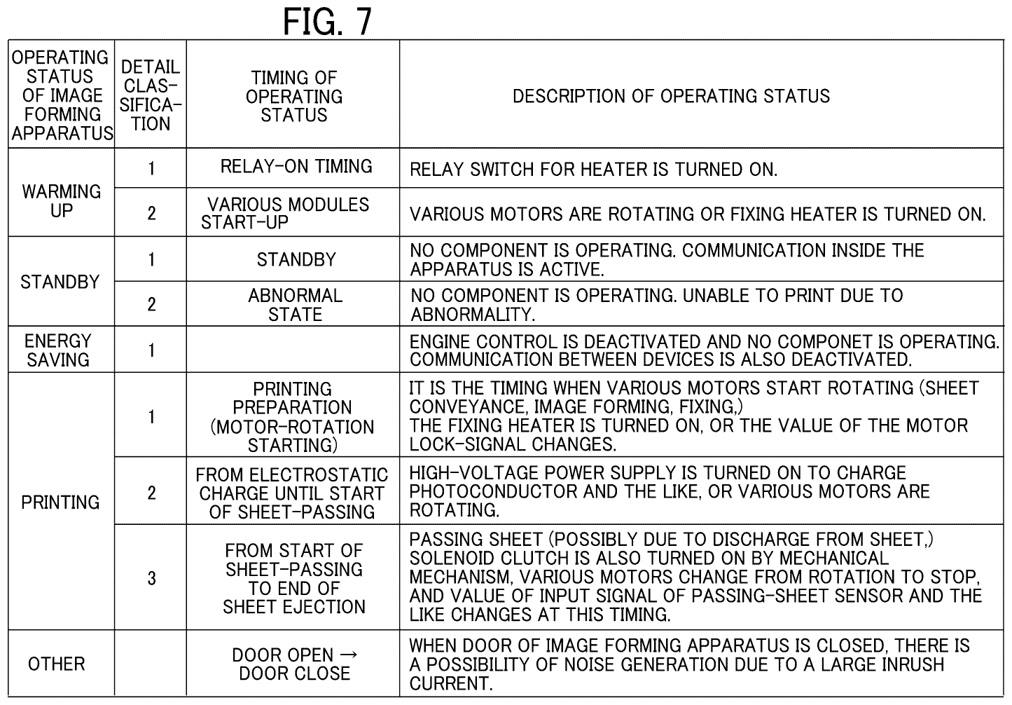

Examples of the operating-status data of the imaging forming apparatus 3 include the operating status of the engine controller 330. Examples of the operating status of the engine controller 330 include warm-up state, standby state, energy-saving state, and printing state. Each state is further classified in detail into several different states. FIG. 7 is a diagram illustrating the details of the operating status of the image forming apparatus 3. Due to the different control methods of the image forming apparatus 3, there are differences in generation of noise, such as the size of the noise, in each status. Therefore, the operating status of the image forming apparatus 3 is relevant to the inference of noise determination.

The ON timing data indicates when electrical components such as a motor and a solenoid are turned on in the engine controller 330. Examples of the ON timing data include data indicating when a relay switch is turned on, when a heater is turned on, and when a high-voltage power supply is turned on. Since the electrical components are likely to generate relatively loud noise during operation, the status of control (ON or OFF) of a load is relevant to the inference of noise determination.

The passing-sheet position data is detected within the engine controller 330. The passing-sheet position data indicates the passing-sheet position within the image forming apparatus 3 during printing. A printing sheet is relevant to the inference of noise determination because the printing sheet retains electrical charges generated by friction with another sheet and may be a source of noise by discharging the charges while the printing sheet is passing.

Examples of the circuit data include external circuit data indicating the impedance of the circuit of the electrical component, which is the source of the signals s1 to sn, within the image forming apparatus 3 outside the engine controller 330. The impedance of the circuit of the electrical component is relevant to the inference of noise determination because characteristics of the circuit include the signal being more susceptible to noise at high impedance and the signal being less susceptible to noise at low impedance.

The input unit 51 acquires from the reception unit 50 the multiple signals s1 to sn, the operating-status data of the image forming apparatus 3, the ON timing data indicating the ON timing, the passing-sheet position data indicating passing-sheet position in the image forming apparatus 3, and the circuit data. The input unit 51 inputs the multiple signals s1 to sn, the operating-status data of the image forming apparatus 3, the ON timing data indicating the ON timing, the passing-sheet position data indicating passing-sheet position in the image forming apparatus 3, and the circuit data to the training unit 52.

The training unit 52 has the machine learning model Ma and generates the pre-trained machine learning model Mb, which can output highly accurate data by the machine learning using a machine learning algorithm including a neural network.

The machine learning model Ma in the present embodiment infers the type of noise indicating that the noise included in each of the signals s1 to sn is the normal noise that is not caused by the abnormality of the image forming apparatus 3 or the abnormal noise that is caused by the abnormality of the image forming apparatus 3, and outputs the type of noise as output data. For example, the training unit 52 acquires the input data including the above-mentioned signal, and outputs the result (the type of noise) indicating that the noise included in the signal (the noise on the signal) is the normal noise or the abnormal noise as the output data.

The training unit 52 further includes a comparison modification unit 53. The comparison modification unit 53 acquires the error E between the output data from the machine learning model Ma and the correct answer data, and calculates the loss L indicating the error E using a loss function. Furthermore, based on the loss L, the comparison modification unit 53 updates parameters including the coupling weighting coefficients between the nodes of the neural network so that the loss L is reduced (so that the loss Lis brought closer to 0). The comparison modification unit 53 updates parameters including the coupling weighting coefficients between the nodes of the neural network using, for example, the error backpropagation method. The error backpropagation method is a method that adjusts parameters including the coupling weighting coefficients between the nodes of each of the neural network so that the error E is reduced.

For example, in the present embodiment, the comparison modification unit 53 compares the output data (the normal noise or the abnormal noise) output from the machine learning model Ma with the correct answer data (the normal noise or the abnormal noise) and modifies the model parameters of the machine learning model Ma based on the error E. Therefore, the training unit 52 performs machine learning of the machine learning model Ma and generates the pre-trained machine learning model Mb.

### Inference Phase

FIG. 6 is a functional block diagram illustrating the image forming apparatus 3 in an inference phase. As illustrated in FIG. 6, the image forming apparatus 3 in the inference phase includes a reception unit 30, an input unit 31, a noise determination unit 35 as an inference unit, an abnormality counting unit 37, a display control unit 38, and a transmission unit 39.

The reception unit 30, the display control unit 38, and the transmission unit 39 are functions implemented by instructions of the CPU 301 illustrated in FIG. 2 based on a program. The input unit 31, the noise determination unit 35, and the abnormality counting unit 37 are functions implemented by instructions of the CPU 400 or the GPU 404 illustrated in FIG. 3 based on a program.

The reception unit 30 receives the data of the pre-trained machine learning model Mb from the machine learning server 5 and passes the data to the noise determination unit 35.

The input unit 31 acquires the multiple signals s1 to sn from, for example, each electrical component outside the engine controller 330 and inside the image forming apparatus 3, detects the signal levels of the signals, and inputs the signal levels to the noise determination unit 35. Noise tends to be propagated in the multiple signals s1 to sn in the housing of the image forming apparatus 3, and noise may easily be included in (be on) the multiple signals s1 to sn simultaneously.

The noise determination unit 35 has the pre-trained machine learning model Mb. The noise determination unit 35 acquires multiple signals s1 to sn from the input unit 31 and acquires each data (the operating-status data of the image forming apparatus 3, the ON timing data, the passing-sheet position data, and the circuit data) from the engine controller 330. The circuit data is stored in a memory such as the RAM 402 or the SSD 403.

The noise determination unit 35 inputs the multiple signals s1 to sn, the operating-status data of the image forming apparatus 3, the ON timing data, the passing-sheet position data, and the circuit data as input data to the pre-trained machine learning model Mb. The noise determination unit 35 causes the pre-trained machine learning model Mb to output, as output data, a determination result (an inference result) indicating whether the type of noise included in the multiple signals s1 to sn is the normal noise or the abnormal noise. The noise determination unit 35 outputs the output data, which is the determination result, to the abnormality counting unit 37. When the output data output from the pre-trained machine learning model Mb indicates the inference result to the effect that the output data is the normal noise, the noise determination unit 35 may not output the output data to the abnormality counting unit 37.

The abnormality counting unit 37 counts the number of the abnormal noises acquired from the noise determination unit 35. When the number of the abnormal noises in a predetermined time exceeds a threshold value (e.g., five times per second), the noise determination unit 35 determines that an abnormality has occurred in the image forming apparatus 3.

When the abnormality counting unit 37 determines that the abnormality has occurred in the image forming apparatus 3, the display control unit 38 displays information indicating that an abnormality has occurred on the panel display 340a illustrated in FIG. 2.

When the abnormality counting unit 37 determines that the abnormality has occurred in the image forming apparatus 3, the transmission unit 39 transmits information indicating that an abnormality has occurred from the network I/F 350 illustrated in FIG. 2 to, for example, a server of the sales office or manufacturer of the image forming apparatus 3.

### Processes or Operation of Embodiment

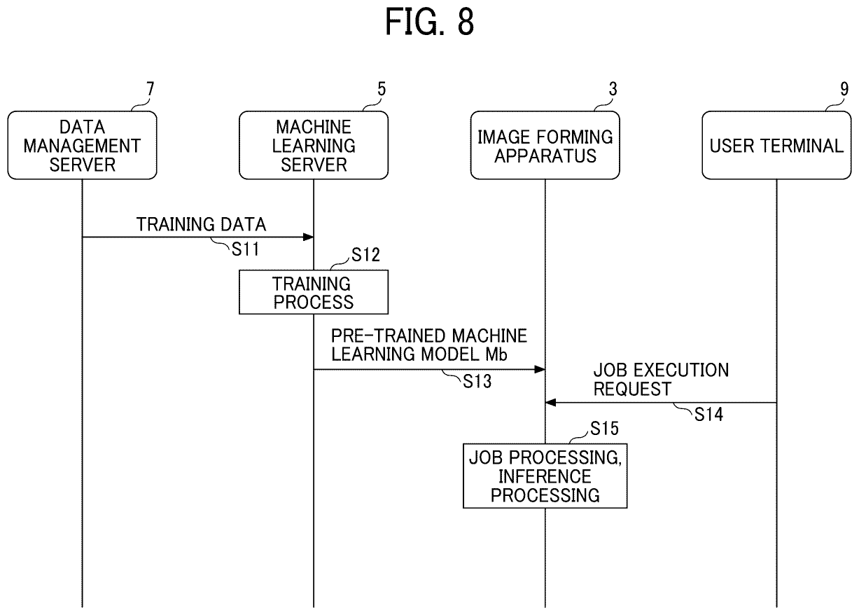

Referring to FIGS. 8 to 10, a description is given of processes or an operation according to the present embodiment.

### Overall Process by Communication System

Referring to FIG. 8, a description is given of an overall process performed by the communication system 1. FIG. 8 is a sequence diagram illustrating an example of a process performed by the communication system 1.

S11: The data management server 7 transmits the training data used for machine learning to the machine learning server 5. Therefore, the reception unit 50 of the machine learning server 5 receives the training data.

S12: The machine learning server 5 performs the training process of the machine learning model Ma using the training data. A detailed description is given later of the training process.

S13: The transmission unit 59 of the machine learning server 5 transmits the data of the pre-trained machine learning model Mb to the image forming apparatus 3. Therefore, the reception unit 30 of the image forming apparatus 3 receives the data of the pre-trained machine learning model Mb.

S14: On the other hand, the user terminal 9 transmits a job execution request such as printing to the image forming apparatus 3. Therefore, the reception unit 30 of the image forming apparatus 3 receives the job execution request.

S15: The image forming apparatus 3 performs job processing in accordance with the job execution request and also performs an inference process. A detailed description is given later of the inference process. The image forming apparatus 3 may execute jobs such as copying or scanning according to direct operation by a user instead of receiving the job execution request from the user terminal 9.

### Training Process

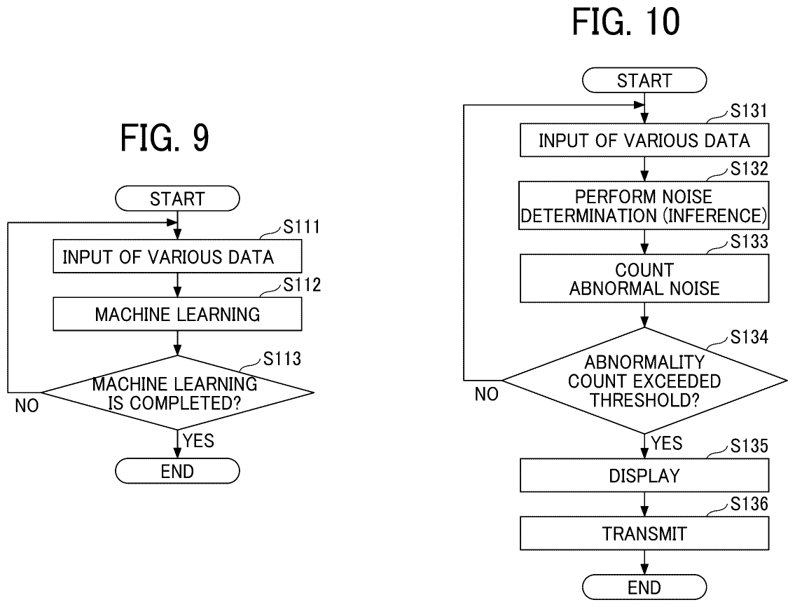

Referring to FIG. 9, a detailed description is given of the training process illustrated in FIG. 8. FIG. 9 is a flowchart illustrating an operation in the learning phase.

S111: The input unit 51 illustrated in FIG. 5 inputs to the training unit 52 the multiple signals s1 to sn, the operating-status data of the image forming apparatus 3, the ON timing data indicating the ON timing, the passing-sheet position data indicating passing-sheet position in the image forming apparatus 3, and the circuit data, as the input data used for machine learning, from among the learning data received by the reception unit 50.

S112: The training unit 52 performs machine learning of the machine learning model Ma based on the input data from, for example, the input unit 51 by the machine learning using a machine learning algorithm including a neural network, and generates the pre-trained machine learning model Mb.

S113: The training unit 52 determines whether machine learning is completed. When machine learning is not completed (S113; NO), the process returns to the step S111 and continues. By contrast, when machine learning is completed (S113; YES), the training process ends.

### Inference Process

Referring to FIG. 10, a detailed description is given of the inference process illustrated in FIG. 8. FIG. 10 is a flowchart illustrating an operation in the inference phase.

S131: The input unit 31 illustrated in FIG. 6 acquires each of the signals s1 to sn output by the various sensors 406 illustrated in FIG. 3 and inputs each of the signals s1 to sn to the noise determination unit 35. The noise determination unit 35 as the inference unit inputs data (the operating-status data of the image forming apparatus 3, the ON timing data, and the passing-sheet position data) from the engine controller 330 and the circuit data stored in, for example, the RAM 402.

S132: The noise determination unit 35 determines (infers) whether the type of noise included in the signals s1 to sn is the normal noise or the abnormal noise based on the signals s1 to sn, the operating-status data of the image forming apparatus 3, the ON timing data, the passing-sheet position data, and the circuit data as the input data, and outputs the output data, which is the determination result.

S133: The abnormality counting unit 37 counts the number of times that the noise is determined to be the abnormal noise by the noise determination unit 35 in the predetermined time.

S134: The abnormality counting unit 37 determines whether the number of times that the abnormal noise has occurred in the predetermined time exceeds the predetermined threshold value. When the number of times that the abnormal noise has occurred in the predetermined time does not exceed the predetermined threshold value (S134; NO), the process returns to S131.

S135: When the number of times that the abnormal noise has occurred in the predetermined time in the process S134 exceeds the predetermined threshold value (S134; YES), the display control unit 38 displays information indicating that the abnormality has occurred in the image forming apparatus 3 on the panel display 340a. Therefore, the user operating the image forming apparatus 3 recognizes that the abnormality has occurred in the image forming apparatus 3.

S136: The transmission unit 39 transmits information to, for example, the user terminal 9 that the abnormality has occurred in the image forming apparatus 3. Therefore, the user operating the user terminal 9 recognizes that the abnormality has occurred in the image forming apparatus 3.

### Another Example of Machine Learning Server

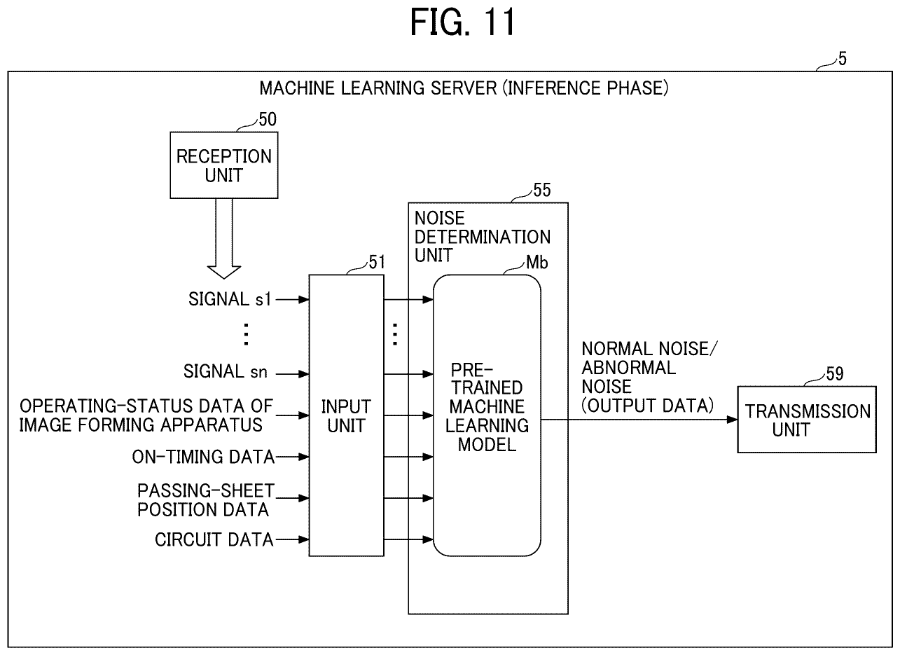

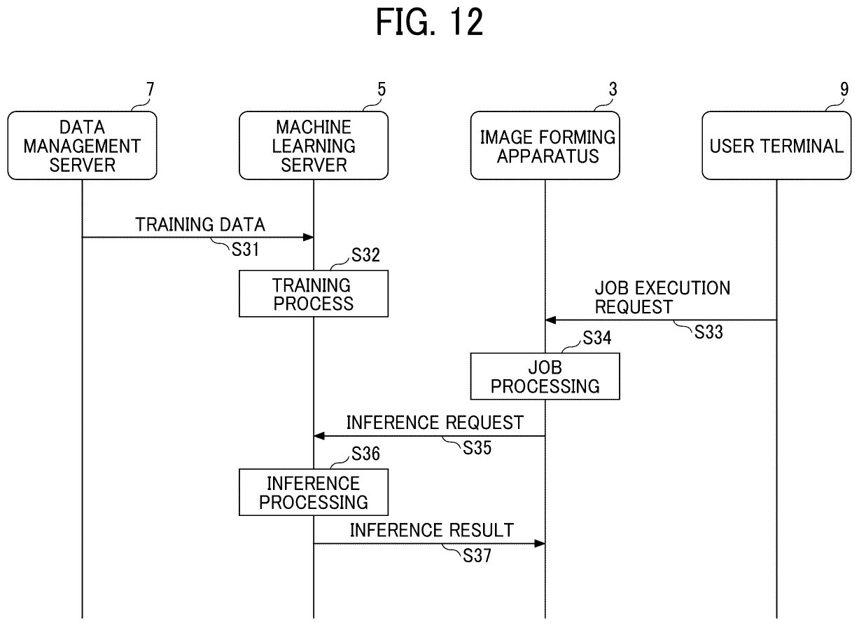

Referring to FIG. 11 and FIG. 12, a description is given of another example of the machine learning server 5. In the above-described embodiment, the image forming apparatus 3 performs the inference process. By contrast, a description is given below of an example in which the machine learning server 5 performs the inference process as an inference server.

### Another Functional Configuration of Machine Learning Server

FIG. 11 is a block diagram illustrating an example of another functional configuration of the machine learning server 5 (an inference server) in the inference phase.

As illustrated in FIG. 11, the machine learning server 5 in the inference phase includes the reception unit 50, the input unit 51, a noise determination unit 55 as an inference unit, and the transmission unit 59. Since the reception unit 50, the input unit 51, and the transmission unit 59 are described with reference to FIG. 5 in the above, the redundant descriptions thereof are omitted.

The noise determination unit 55 is a function implemented by instructions of the CPU 500 or the GPU 504 illustrated in FIG. 4 based on a program. The noise determination unit 55 has the pre-trained machine learning model Mb that which the machine learning server 5 itself has learned.

### Another Overall Process by Communication System

Referring to FIG. 12, a description is given of an overall process performed by the communication system 1 when the machine learning server 5 performs the inference process. FIG. 12 is a sequence diagram illustrating another example 1 of a process performed by the communication system 1.

S31: The data management server 7 transmits the training data used for machine learning to the machine learning server 5. Therefore, the reception unit 50 of the machine learning server 5 receives the training data.

S32: The machine learning server 5 performs the training process of the machine learning model Ma using the training data. Since the training process is described with reference to FIG. 9 in the above, the redundant description thereof is omitted.

S33: On the other hand, the user terminal 9 transmits a job execution request such as printing to the image forming apparatus 3. Therefore, the reception unit 30 of the image forming apparatus 3 receives the job execution request.

S34: The image forming apparatus 3 performs job processing in accordance with the job execution request. The image forming apparatus 3 may execute jobs such as copying according to direct operation by a user instead of receiving the job execution request from the user terminal 9.

S35: The transmission unit 39 of the image forming apparatus 3 transmits an inference request to the machine learning server 5. The inference request includes signals s1 to sn and data (the operating-status data of the image forming apparatus 3, the ON timing data, the passing-sheet position data, and the circuit data) to be used by the noise determination unit 35 illustrated in FIG. 6 to infer the type of noise (the normal noise or the abnormal noise). Therefore, the reception unit 50 of the machine learning server 5 receives the inference request.

S36: The machine learning server 5 as an inference server performs the inference process. Since the inference process is the same or substantially the same as that described with reference to FIGS. 10 (S131 and S132) in the above, the redundant description thereof is omitted.

S37: The transmission unit 59 of the machine learning server 5 transmits the data of the inference result in response to the inference request of the process S35 to the image forming apparatus 3. The inference result includes information indicating whether the type of noise included in the signals s1 to sn is the normal noise or the abnormal noise. Therefore, the reception unit 30 of the image forming apparatus 3 receives the data of the inference result.

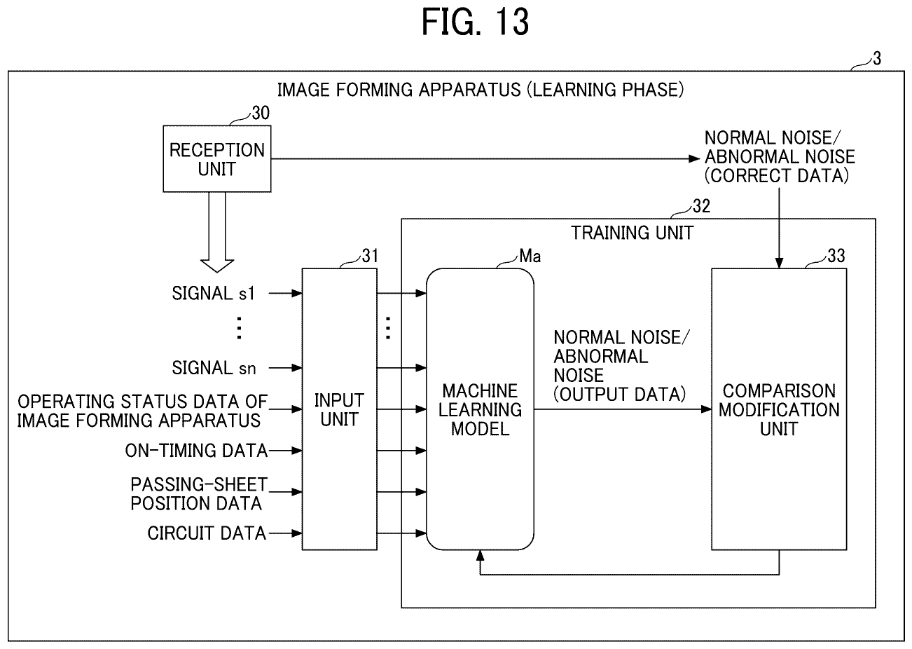

Then, the abnormality counting unit 37 of the image forming apparatus 3 performs a process that is the same or substantially the same as the processes S133 and S134 illustrated in FIG. 10. When the number of times that the abnormal noise has occurred in the predetermined time does not exceed the predetermined threshold value (S134; NO), the process returns to S35 illustrated in FIG. 13. When the number of times that the abnormal noise has occurred in the predetermined time exceeds the predetermined threshold value (S134; YES), the process proceeds to S135 and S136 illustrated in FIG. 10.

The machine learning server 5 illustrated in FIG. 11 may have the same or substantially the same functions as the abnormality counting unit 37 of the image forming apparatus 3. The data of the inference result transmitted in S37 illustrated in FIG. 13 includes information that an abnormality has occurred in the image forming apparatus 3.

### Another Example of Image Forming Apparatus

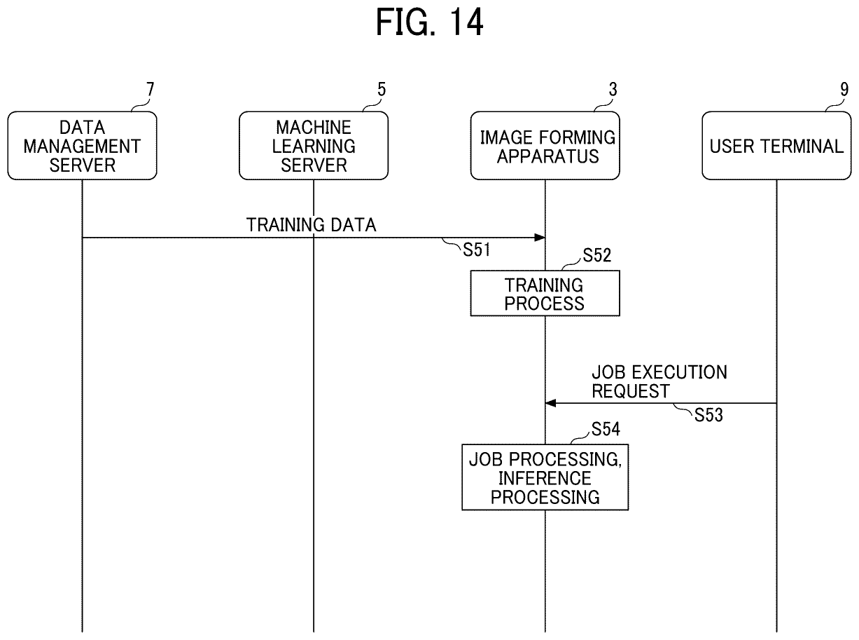

Referring to FIG. 13 and FIG. 14, a description is given of another example of the image forming apparatus 3. In the above-described embodiment, the machine learning server 5 performs the training process. By contrast, a description is given below of an example in which the image forming apparatus 3 performs the training process.

### Another Functional Configuration of Image Forming Apparatus

FIG. 13 is a functional block diagram illustrating the image forming apparatus 3 in the learning phase.

As illustrated in FIG. 13, the image forming apparatus 3 in the learning phase includes the reception unit 30, the input unit 31, and a training unit 32. Since the reception unit 30 and the input unit 31 are described with reference to FIG. 6 in the above, the redundant descriptions thereof are omitted.

The training unit 32 is a function implemented by instructions of the CPU 400 or the GPU 404 illustrated in FIG. 3 based on a program. Furthermore, the training unit 32 initially has the machine learning model Ma, but after machine learning, the training unit 32 has the pre-trained machine learning model Mb. When the training unit 32 has the pre-trained machine learning model Mb, the training unit 32 performs additional learning.

The training unit 32 has a comparison modification unit 33, which functions similarly to the comparison modification unit 53. The comparison modification unit 33 compares the output data (the normal noise or the abnormal noise) output from the machine learning model Ma or the pre-trained machine learning model Mb with the correct answer data (the normal noise or the abnormal noise) and modifies the model parameters of the machine learning model Ma or the pre-trained machine learning model Mb based on the error E. Therefore, the training unit 32, by performing machine learning of the machine learning model Ma, generates the pre-trained machine learning model Mb or performs the additional learning (reinforcement learning) of the pre-trained machine learning model Mb.

### Another Overall Process by Communication System

Referring to FIG. 14, a description is given of an overall process performed by the communication system 1 when the image forming apparatus 3 performs the training process. FIG. 14 is a sequence diagram illustrating another example 2 of a process performed by the communication system 1.

S51: The data management server 7 transmits the training data used for machine learning to the image forming apparatus 3. Therefore, the reception unit 30 of the image forming apparatus 3 receives the training data.

S52: The image forming apparatus 3 performs the training process of the machine learning model Ma using the training data. Since the training process is described with reference to FIG. 9 in the above, the redundant description thereof is omitted.

S53: On the other hand, the user terminal 9 transmits a job execution request such as printing to the image forming apparatus 3 in the same or substantially the same manner as the process S14. Therefore, the reception unit 30 of the image forming apparatus 3 receives the job execution request.

S54: The image forming apparatus 3 performs job processing in accordance with the job execution request and also performs an inference process in the same or substantially the same manner as the process S15. The image forming apparatus 3 may execute jobs such as copying or scanning according to direct operation by a user instead of receiving the job execution request from the user terminal 9.

As described above, according to one or more embodiments of the present disclosure, the accuracy of determining whether the noise in the signal output from the electrical component of the image forming apparatus 3 is the normal noise that is not caused by the abnormality of the image forming apparatus 3 or the abnormal noise that is caused by the abnormality of the image forming apparatus 3, at least by determining based on the operating status of the image forming apparatus 3, is enhanced.

Furthermore, the above accuracy is further enhanced by considering at least one data of the ON timing data indicating when the electrical component is turned on, the circuit data indicating the impedance of the circuit of the electrical component, and the passing-sheet position data indicating the passing-sheet position in the image forming apparatus 3.

The above-described embodiments are illustrative and do not limit the present disclosure. Thus, numerous additional modifications and variations are possible in light of the above teachings.
(1) In communications between the image forming apparatus 3, the machine learning server 5, the data management server 7, and the user terminal 9, another device such as a server or a router may relay various data. For example, for the sake of simplicity, the present specification describes that the image forming apparatus 3 receives data (information) from the machine learning server 5 and that the image forming apparatus 3 transmits data (information) to the machine learning server 5. However, each of the receiving and transmitting processes also includes cases in which another device relays the data (information).
(2) Each function of the embodiments described above can be implemented by one or more processing circuits. Processing circuitry includes a programmed processor, as a processor includes circuitry. A processing circuit also includes devices such as an application specific integrated circuit (ASIC), a digital signal processor (DSP), a field programmable gate array (FPGA), and conventional circuit modules arranged to perform the recited functions.
(3) The illustrated programs may be stored in a non-transitory recording medium such as a DVD-ROM, and distributed in the form of a program product to domestic or foreign users.
(4) The number of each processor (e.g., the CPU 301, the CPU 400, the GPU 404, the CPU 500, or the GPU 504) may be one or more.

The number of noise occurrences varies depending on the operating status of the electronic apparatus, such as when the electronic apparatus is in standby mode or when the electronic apparatus is operating a job. Therefore, even if the number of noise occurrences in a given period of time exceeds a threshold value, the abnormality may not occur in the electronic apparatus yet. Even in such cases, forcing the electronic apparatus to, e.g., stop would confuse the user.

According to one or more embodiments of the present disclosure, the accuracy of judging whether the noise is normal noise that is not caused by the abnormality of the electronic apparatus or abnormal noise that is caused by the abnormality of the electronic apparatus is enhanced.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

1. An electronic apparatus comprising:
an electrical component to generate a signal; and
circuitry configured to determine, based on an operating status of the electronic apparatus, a type of noise indicating that the noise included in the signal is a normal noise not caused by an abnormality of the electronic apparatus or an abnormal noise caused by the abnormality of the electronic apparatus.

2. The electronic apparatus according to claim 1,
wherein the circuitry determines the type of noise by inferring the type of noise in the signal based on the signal and data indicating the operating status of the electronic apparatus, using a pre-trained machine learning model,
the pre-trained machine learning model being configured to input the signal and the data indicating the operating status of the electronic apparatus as input data and output the type of noise as output data.

3. The electronic apparatus according to claim 2,
wherein the operating status is one of a warm-up state, a standby state, and an energy-saving state of the electronic apparatus.

4. The electronic apparatus according to claim 3,
wherein the one of the warm-up state, the standby state, and the energy-saving state includes a plurality of different states.

5. The electronic apparatus according to claim 3,
wherein the electronic apparatus is an image forming apparatus, and the operating status further includes a printing state.

6. The electronic apparatus according to claim 5,
wherein the printing state includes a plurality of different states.

7. The electronic apparatus according to claim 2,
wherein the input data include ON timing data indicating when the electronic apparatus is turned on and circuit data indicating impedance of a circuit of the electrical component within the electronic apparatus, and
wherein the circuitry infers the type of noise based on the ON timing data or the circuit data.

8. The electronic apparatus according to claim 7,
wherein the electronic apparatus is an image forming apparatus, and the input data includes passing-sheet position data indicating passing-sheet position within the image forming apparatus during printing, and
wherein the circuitry infers the type of noise based on the passing-sheet position data.

9. The electronic apparatus according to claim 1,
wherein the circuitry is further configured to count the number of times the noise is determined to be the abnormal noise, and determine that the abnormality has occurred in the electronic apparatus when the number of times the noise is determined to be the abnormal noise for a predetermined period of time exceeds a threshold value.

10. An electronic system comprising:
an electronic apparatus including an electrical component to generate a signal; and
an inference server communicably connected with the electronic apparatus, the inference server including:
circuitry configured to determine a type of noise indicating that the noise included in the signal is a normal noise not caused by an abnormality of the electronic apparatus or an abnormal noise caused by the abnormality of the electronic apparatus, by inferring the type of noise in the signal based on the signal and data indicating an operating status of the electronic apparatus using a pre-trained machine learning model, the pre-trained machine learning model being configured to input the signal and the data indicating the operating status of the electronic apparatus as input data and output the type of noise as output data.

11. A noise determination method comprising:
acquiring a signal generated in an electrical component included in an electronic apparatus; and
determining, based on an operating status of the electronic apparatus, a type of noise indicating that the noise included in the signal is a normal noise not caused by an abnormality of the electronic apparatus or an abnormal noise caused by the abnormality of the electronic apparatus.

12. A non-transitory recording medium storing a plurality of instructions which, when executed by one or more processors, causes the one or more processors to perform the noise determination method of claim 11.
